(19) United States
(12) Patent Application Publication
(10) Pub. No.: US 2018/0122013 A1
(43) Pub. Date: May 3, 2018

(54) SYSTEM, METHOD, AND APPARATUS FOR MANAGING PRIVATE PLACEMENT INVESTMENTS

(71) Applicant: Caspian Private Equity, New York, NY (US)

(72) Inventor: Satyan MALHOTRA, New York, NY (US)

(21) Appl. No.: 15/572,414

(22) PCT Filed: May 11, 2016
(86) PCT No.: PCT/US16/31812

§ 371 Date: Nov. 7, 2017

Related U.S. Application Data
(60) Provisional application No. 62/159,557, filed on May 11, 2015.

(51) Int. Cl. G06Q 40/06

(52) U.S. Cl. CPC G06Q 40/06

(57) ABSTRACT

An approach is provided for managing financial investments in private placements. The approach involves receiving by a fund managing entity associated with a computer over a network a request from a device associated with the user for managing financial resources. The approach also involves determining by the fund managing entity a split percentage for the financial resources based, at least in part, on a risk level. The approach further involves investing by the fund managing entity the financial resources in a publicly traded security, a private placement, or a combination thereof based, at least in part, on the split percentage. The approach also involves monitoring by the fund managing entity performances of the financial resources invested in the publicly traded security, the private placement, or a combination thereof.

### CROSS-REFERENCES TO RELATED APPLICATIONS

This PCT application claims priority from U.S. Provisional Application Ser. No. 62/159,557 by Satyan Malhotra, entitled “SYSTEM, METHOD, AND APPARATUS FOR MANAGING PRIVATE PLACEMENT INVESTMENTS,” and filed May 11, 2015, the contents of which are hereby incorporated herein in their entirety by this reference.

### BACKGROUND

An important aspect of managing funds is the optimal utilization of financial instruments (e.g., money, stocks, shares, etc.) that are available for investment by its investors. For example, investors generally seek to make investments with high returns within a selected risk profile while also considering other characteristics such as liquidity, income potential, price, growth potential, etc. For many investors, liquidity can be related to the evaluation of risks. For example, investments that can be quickly converted to cash or other desired instruments can be considered as less risky than similar less-liquid instruments. Therefore, investors seeking to manage risk generally prefer instruments that can be traded or redeemed as compared to those that cannot. Investors generally invest in publicly traded securities or in private placements. Conventionally, private placements are offered to investors within frameworks that have limited or structured liquidity e.g., closed-end mutual funds, structured products, etc. However, when investing in such frameworks, investors may find it difficult to redeem shares due to the complexity in selling underlying private placement investments before satisfaction of associated requirements (e.g., completion of a pre-defined time period). Further, some private placements cannot be transacted through global exchanges, for example, New York Stock Exchange (NYSE), NASDAQ Stock Exchange (NASDAQ), and so forth. As a result, investors may avoid or reduce their exposure to private place investments in favor of publicly traded securities that can be easily sold and can be transacted via global exchanges.

Therefore, there is a need for managing financial investments in private placements.

### BRIEF DESCRIPTION OF THE DRAWINGS

The embodiments of the invention are illustrated by way of example, and not by way of limitation, in the figures of the accompanying drawings:

FIG. 1 is a diagram of a system architecture capable of monitoring performances of the financial resources invested in a publicly traded security, a private placement, or a combination thereof, according to one embodiment;

FIG. 2 is a diagram of the components of the fund management platform 115, according to one example embodiment;

FIG. 3 is a block diagram of the system for managing financial investments, according to one embodiment;

FIG. 4 is a flowchart of a process for monitoring performances of the financial resources invested in a publicly traded security, a private placement, or a combination thereof, according to one embodiment;

FIG. 5 is a flowchart of a process for managing financial investments, according to another embodiment;

FIG. 6 is a diagram of a computer system that can be used to implement various exemplary embodiments;

FIG. 7 is a diagram of a chip set upon which an embodiment of the invention may be implemented, according to various embodiments;

FIG. 8 is a diagram of a mobile station (e.g., a handset) that can be used to implement an embodiment of the invention; and

FIG. 9 is a diagram of a backend server system that can be used to implement an embodiment of the invention.

### DESCRIPTION OF SOME EMBODIMENTS

A method, apparatus, and system for managing financial investments are herein described. In the following description, for the purposes of explanation, numerous specific details are set forth in order to provide a thorough understanding of the preferred embodiments of the invention. It is apparent, however, that the embodiments may be practiced without these specific details or with an equivalent arrangement. In other instances, well-known structures and devices are shown in block diagram form in order to avoid unnecessarily obscuring the preferred embodiments of the invention.

Although various exemplary embodiments are described with respect to mutual funds, it is contemplated that these embodiments have applicability to any other type of financial instrument. For example, it is contemplated that other financial instruments such as Collective Investment Trusts (CIT), Undertakings for Collective Investment in Transferable Securities (UCIT), structured products, stocks, shares, and/or any other instrument can be used with the processes of the various embodiments. Moreover, although various embodiments are discussed with respect to investors who are fund managers, it is contemplated that in various embodiments, the investor can be any entity or individual (e.g., institutional investors, individual investors, etc.).

As noted above, private placements generally are offered only within some closed-end mutual fund frameworks because of the complexity of selling private placements if an investor of the fund wants to redeem shares. Other fund managers and/or types of mutual fund frameworks (e.g., open-end mutual fund frameworks) have generally avoided private placements because of such selling complexities and associated reduced liquidity. Instead, other mutual funds have traditionally invested in publicly traded securities that can be easily sold and are transacted, thereby potentially missing out on returns that can be generated from private placements.

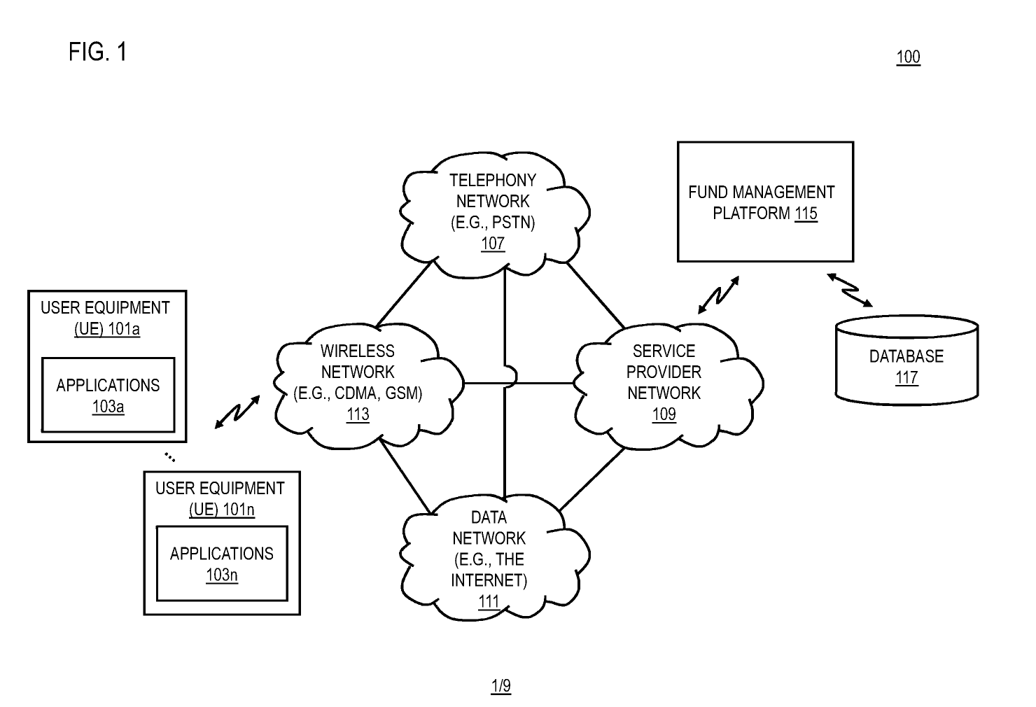

To address this need, the system 100 of FIG. 1 introduces the capability for managing financial investments in private placements that may be offered in open-end mutual fund frameworks or other investment frameworks that favor greater liquidity. As shown in FIG. 1, the system 100 comprises user equipment (UE) 101a-101n (collectively referred to as UE 101) that may include or be associated with applications 103a-103n (collectively referred to as applications 103). In one embodiment, the UE 101 has connectivity to the fund management platform 115 via networks 107-113. In other words, the system 100 introduces a special purpose vehicle (SPV) for making one or more private placement investments. More specifically, the SPV seeks to increase the liquidity of private placement investments to facilitate such investments by entities that have traditionally avoided them (e.g., open-end mutual fund frameworks, risk-averse fund managers of closed-end mutual fund frameworks, etc.).

By way of example, the UE 101 may be, but not restricted to, a computer, a laptop, a Personal Digital Assistance (PDA), a tablet, a smart phone, a palmtop, a notebook, a mobile phone, or any other computing device. It is also contemplated that the UE 101 may support any type of user interface for supporting the presentment of data. In addition, the UE 101 may facilitate various input means for receiving, including, but not restricted to, a touch screen input mechanism, a keyboard and keypad data entry, a voice-based input mechanism, and/or the like. It is also contemplated that the UE 101 can support any type of interface to the user (such as “wearable” circuitry, etc.). In an embodiment, the users (e.g., investors) may communicate with the fund management platform 115 via UE 101.

In one embodiment, the users may invest in financial instruments within an open-end mutual funds frameworks and/or other type of mutual fund framework. Then, the users may interact with the fund management platform 115 to manage their financial investments via their respective UE 101. In an exemplary scenario, the financial investments may include, but are not restricted to, assets, financial instruments, etc. In one embodiment, assets may include, but are not restricted to, items of property, such as real property, personal property, tangible, or intangible property, shares of stocks listed in public exchanges, and/or the like. In one embodiment, financial instruments may include, but are not restricted to, debt obligations, ownership units, contract agreements, bonds, mutual funds, cash, and/or the like.

By way of example, the applications 103 may be any type of application that is executable at the UE 101, such as analytical software application or service such as, but not restricted to, financial statement analysis software, financial planning software, financial accounting software, portfolio management software, communications software, and/or the like. In one embodiment, one of the applications 103 at the UE 101 may act as a client for the fund management platform 115 and may perform one or more functions associated with the functions of the fund management platform 115 by interacting with the fund management platform 115 over the networks 107-113. In one embodiment, the UE 101 may include an Operating System (OS). The OS may provide basic execution environment for the applications on the UE 101.

For illustrative purposes, the networks 107-113 may be any suitable wireline and/or wireless network, and be managed by one or more service providers. For example, telephony network 107 may include a circuit-switched network, such as the public switched telephone network (PSTN), an integrated services digital network (ISDN), a private branch exchange (PBX), or other like network. For instance, the service provider network 109 may embody circuit-switched and/or packet-switched networks that may include facilities to provide for transport of circuit-switched and/or packet-based communications. The wireless network 113 may employ various technologies including, for example, code division multiple access (CDMA), enhanced data rates for global evolution (EDGE), general packet radio service (GPRS), mobile ad hoc network (MANET), global system for mobile communications (GSM), Internet protocol multimedia subsystem (IMS), universal mobile telecommunications system (UMTS), etc., as well as any other suitable wireless medium, e.g., microwave access (WiMAX), wireless fidelity (WiFi), satellite, and the like. Meanwhile, data network 111 may be any local area network (LAN), metropolitan area network (MAN), wide area network (WAN), the Internet, or any other suitable packet-switched network, such as a commercially owned, proprietary packet-switched network, such as a proprietary cable or fiber-optic network.

Although depicted as separate entities, networks 107-113 may be completely or partially contained within one another, or may embody one or more of the aforementioned infrastructures. It is further contemplated that networks 107-113 may include components and facilities to provide for signaling and/or bearer communications between the various components or facilities of system 100. In this manner, networks 107-113 may embody or include portions of a signaling system 7 (SS7) network, or other suitable infrastructure to support control and signaling functions. In addition, the system 100 may operate as separate parts that rendezvous and synchronize periodically to form a larger system with similar characteristics. In an embodiment, one or more users may communicate with the fund management platform 115 through networks 107-113 via their respective UE 101. In one embodiment, the one or more users may also communicate with the fund management platform 115 via short range communication techniques, such as, Bluetooth™, Near Field Communication (NFC), Infrared (IR), ultra-band, Zigbee, and/or the like. The one or more users may directly communicate with the fund management platform 115, in another embodiment.

In one embodiment, the fund management platform 115 may be a platform with multiple interconnected components. The fund management platform 115 may include multiple servers, intelligent networking devices, computing devices, components and corresponding software for monitoring performances of the financial resources invested in a publicly traded security, a private placement, or a combination thereof. In addition, it is noted that the fund management platform 115 may be a separate entity of the system 100, or included within the UE 101 (e.g., as part of the applications 103). In another embodiment, the fund management platform 115 may be an entity associated with a computer for administering financial portfolio of a user.

In one embodiment, the fund management platform 115 may perform a function of an SPV for making one or more private placement investments. More specifically, the fund management platform 115 may increase the liquidity of private placement investments to facilitate such investments by entities that have traditionally avoided them (e.g., open-end mutual fund frameworks, risk-averse fund managers of closed-end mutual fund frameworks, etc.). In one example embodiment, the fund management platform 115 may receive a request from a user. The request may be to manage financial investments within open-end mutual funds framework offered in private placements. In one embodiment, the fund management platform 115 determines a split percentage of the investment into the publicly traded securities and private placements, or a combination thereof. For example, the fund management platform 115 may determine the split percentage based on risk appetite of the user (e.g., investor). In one embodiment, the risk appetite may be defined as a level of risk that a user may be prepared to accept. For example, a user may hold the opinion that a greater risk appetite or tolerance potentially can lead to greater returns while a lower risk appetite or tolerance potentially can lead to lower returns. In one embodiment, the risk appetite of the user may be defined as investor profile in the fund management platform 115. For example, the user may identify explicit risk levels or may include user-defined criteria for specifying investment risk levels.

In one embodiment, the fund management platform 115 may determine the investment allocation or percentage split to invest in the publicly traded securities, private placements, or a combination thereof, based on the risk appetite of the user (e.g., as determined from the user profile information described above). For example, in an example scenario, where investing in private placements is designated at a higher risk level than inventing in publicly traded securities, the fund management platform 115 may specify a higher allocation or percentage split to the SPV for a user with a higher risk appetite and a lower allocation to the SPV for a user with a lower risk appetite.

Further, the fund management platform 115 may monitor the fund performance over a period of time, in an embodiment. In an exemplary scenario, if the price of the mutual fund invested in private placement is decreasing, which further results into loss, then the fund management platform 115 may manage the mutual fund investments by selling the mutual funds to a manager of secondary funds. A secondary fund may be a private equity secondary market that purchases or sells pre-existing investor commitments to private placements or equity or other investment funds. The users may gain liquidity and manage their portfolios by trading with the secondary funds. In another exemplary scenario, if the price of the mutual fund invested in private placement is decreasing, which further results in potential losses, then the fund management platform 115 may manage the mutual fund investments by investing in mutual funds that may give higher returns to the user. In yet another exemplary scenario, if the price of the mutual fund invested in private placement is increasing, which further results into profit, then the fund management platform 115 may manage the mutual fund investments by purchasing the same mutual funds from the manager of the secondary funds, which may give higher returns to the user.

In one embodiment, the fund management platform 115 may manage the funds associated with private placements offered within the open-end mutual funds framework in two ways. In an embodiment, the fund management platform 115 may actively manage the funds associated with the private placements where the fund manager may invest in funds based on analytical research, forecast, their experience and/or the like, and may have a specific goal such as, achieving a level of return while assuming a risk level. In another embodiment, the fund manager may passively manage the funds associated with private placements based on the offering returns. In other words, the fund manager may passively purchase and/or sell the mutual funds as per pre-defined schemes of a company.

In one embodiment, the fund management platform 115 may manage the liquidity of private placements by generating letters of intent (e.g., open letters of intent or firm purchase and sale agreements) for reference by the system 100 and/or storage in database 117. In another embodiment, individual users may generate the open letters of intent and may also provide prices for purchasing the investments (e.g., daily, weekly, monthly, other) for reference by the system 100 and/or storage in database 117. The letters of intent is entered between a user (e.g., a fund manager) and other users (e.g., other fund managers) that buy private placements (e.g., secondary funds) to purchase the private placements if the user chooses to sell the private placement investments. These open letters of intent or firm purchase and sale agreements may be with or without commitment fees. In one embodiment, the fund management platform 115 may query for the letter of intent or one or more terms of the letter of intent from database 117 of the system 100. Then, the private placement investments and/or a sale of the private place investment may be initiated based on the results of the querying.

By way of example, the need to sell the private placement investments may arise for general rebalancing purposes, if the underlying mutual fund investor wants to sell shares and the mutual fund investor wants to liquidate the private placements along with registered or publicly traded securities. In one embodiment, the fund management platform 115 may determine transactions terms based on default rules, terms defined in the letters of intent, terms defined by the investors, and so on upon receiving a request for selling the shares. In addition, the terms may be defined at the time of sale, at the time of the letter of intent, and/or any other time specified by the fund management platform 115 and/or the investors.

In one embodiment, the fund management platform 115 may further determine an investment allocation or percentage split between publicly traded securities and the various embodiments of the SPV described herein. For example, the percentage split between the allocations can depend on or be determined from the risk appetite of the underlying user (e.g., fund manager) or the regulations the offering is subject to (e.g., Mutual Funds). In one embodiment, the fund management platform 115 operates in support of management of a mutual fund registered with the U.S. Securities and Exchange Commission (SEC) under the Investment Act of 1940. Accordingly, the fund management platform 115 may comply with standard mutual fund procedures and regulations other than the composition and mechanics of the SPV as discussed with respect to the various embodiments described herein. In another embodiment, the fund management platform 115 may determine the allocation or split based on opportunity driven parameters or criteria (e.g., available investments, redemptions, etc.).

In one embodiment, the fund management platform 115 may be configured to initiate investments in any publicly traded securities. In another embodiment, the fund management platform 115 may be configured for investment in a specified subset of publicly traded securities (e.g., securities offered by entities that manage or have exposure to illiquid assets (e.g., private equity, real estate, infrastructure, business development company (BDC), etc.).

In one embodiment, the database 117 may store open letters of intent, firm purchase and sale agreements, prices for purchasing one or more investments, or a combination thereof. The information may be any multiple types of information that can provide means for aiding in the content provisioning and sharing process.

By way of example, the UE 101, the fund management platform 115 communicate with each other and other components of networks 107-113 using well known, new or still developing protocols. In this context, a protocol includes a set of rules defining how the network nodes within the networks 107-113 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers as defined by the OSI Reference Model.

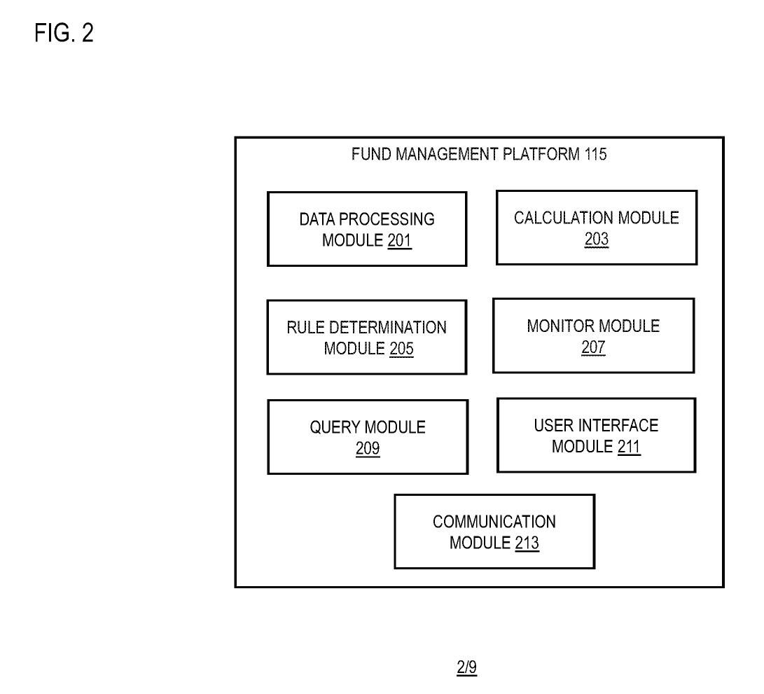

FIG. 2 is a diagram of the components of the fund management platform 115, according to one example embodiment. By way of example, the fund management platform 115 includes one or more components for monitoring performances of the financial resources invested in a publicly traded security, a private placement, or a combination thereof. It is contemplated that the functions of these components may be combined in one or more components or performed by other components of equivalent functionality. In one embodiment, the fund management platform 115 comprises one or more data processing modules 201, calculation modules 203, rule determination modules 205, monitor modules 207, query modules 209, user interface modules 211 and communication modules 213 or any combination thereof.

In one embodiment, the fund management platform 115 may receive a request from one or more users to manage their financial resources, whereupon the data processing module 201 may process and store financial data for the one or more users. It is contemplated that the data processing module 201 may use any textual recognition, image recognition, object recognition, audio recognition, speech recognition, etc. techniques for identifying potential text, images, audio, and the like from relevant data sets.

In one embodiment, the calculation module 203 may compute risk level for one or more users based, at least in part, on user activity information, user profile information, or a combination thereof. In another embodiment, the calculation module 203 may compute risk level for a publicly traded security, a private placement, or a combination thereof based, at least in part, on analytical research, market forecast, and so on. In a further embodiment, the calculation module 203 may compute returns on the financial resources invested in the publicly traded security, a private placement, or a combination thereof. The return on an investment may be measured over a given time period by summing its capital appreciation and income generated and dividing the summation by the original amount of the investment. In one example embodiment, the calculation module 203 may designate higher risk level for investments in private placements as compared to investments in publicly traded securities if the returns on the investments in private placements are low.

In one embodiment, the rule determination module 205 may invest financial resources of the one or more users in a publicly traded security, a private placement, or a combination thereof based on the computed risk level. In another embodiment, the rule determination module 205 may invest financial resources of the one or more users in a publicly traded security, a private placement, or a combination thereof based on pre-defined schemes of a company. In one example embodiment, the rule determination module 205 may cause a higher percentage split to the SPV for investment in private placements for a user with a higher risk appetite. In another example embodiment, the rule determination module 205 may cause a higher percentage split to the SPV for investment in a publicly traded security for a user with a lower risk appetite.

In one embodiment, the monitor module 207 may monitor the performance of the financial resources invested in the publicly traded security, the private placements, or a combination thereof over a period of time. In one example embodiment, the monitor module 207 may recommend a user (e.g., fund manager) to sell the investments in the private placements if the value of the investment is decreasing and is resulting into loss. In another example embodiment, the monitor module 207 may recommend a user (e.g., fund manager) to purchase investments in the private placements if the value of the investment is increasing and may likely yield profit.

In one embodiment, the query module 209 may query the database 117 for letter of intent, one or more terms of the letter of intent, one or more agreements, or a combination thereof. In another embodiment, the query module 209 may query the database 117 for pre-defined price for trading of the investments at the time of the agreement of intent. In one example embodiment, the fund management platform 115 may initiate one or more private placement investments based on the querying.

In one embodiment, the user interface module 211 may enable presentation of a graphical user interface (GUI) in at least one UE 101. The user interface module 211 employs various application programming interfaces (APIs) or other function calls corresponding to the applications 103 of UE 101, thus enabling the display of graphics primitives such as icons, menus, buttons, data entry fields, etc., for generating the user interface elements. In another embodiment, the user interface module 211 may cause an interfacing of the guidance information with one or more users to include, at least in part, the one or more annotations, audio messages, or a combination thereof. In a further embodiment, user interface module 211 may display the performance of the investments on the GUI. Further, the display 512 may be a touch-enabled display such as capacitive or resistive screen.

In one embodiment, the communication module 213 may also be used to communicate commands, requests, data, etc. between the UEs 101, the fund management platform 115, the applications 103 and the database 117.

The above presented modules and components of the fund management platform 115 can be implemented in hardware, firmware, software, or a combination thereof. Though depicted as a separate entity in FIG. 1, it is contemplated that the fund management platform 115 may be implemented for direct operation by respective UE 101. As such, the fund management platform 115 may generate direct signal inputs by way of the operating system of the UE 101 for interacting with the applications 103. In another embodiment, one or more of the modules 201-213 may be implemented for operation by respective UEs, as the fund management platform 115, or combination thereof. Still further, the fund management platform 115 may be integrated for direct operation with the one or more services, such as in the form of a widget or applet, in accordance with an information and/or subscriber sharing arrangement. The various executions presented herein contemplate any and all arrangements and models.

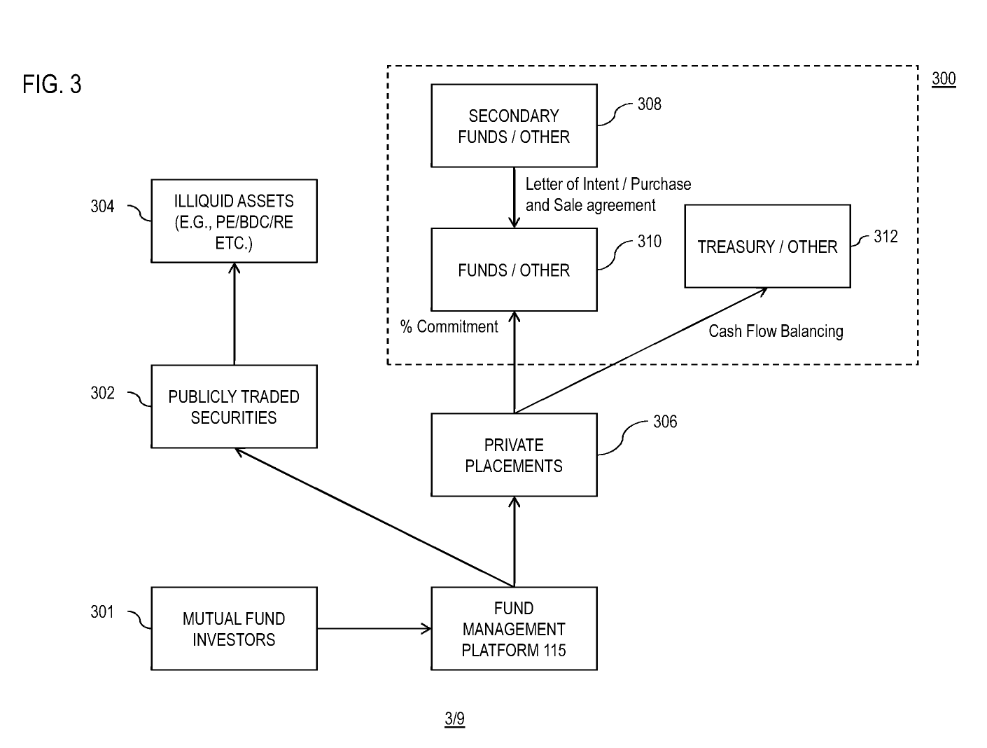

FIG. 3 is a block diagram of the system 100 for managing financial investments, according to one embodiment. The mutual fund investor 301 (e.g., users) desires to invest in publicly traded securities 302 (or publicly listed private equity or publicly quoted private equity), private placements 306 (via SPV), or a combination thereof. The mutual fund investor 301 communicates with the fund management platform 115 to invest in the publicly traded securities 302, private placements 306, or a combination thereof. The fund management platform 115 may then determine a split percentage of the financial investment associated with the mutual fund investor 301 into the publicly traded securities 302, private placements 306, or a combination thereof, in an embodiment.

In one embodiment, the fund management platform 115 may determine the split percentage of the financial investment based on the risk appetite of the mutual fund investor 301. In another embodiment, the fund management platform 115 may determine the split percentage of the financial investment based on the risk appetite of the fund manager of the fund management platform 115. In a further embodiment, the fund management platform 115 may determine the split percentage of the financial investment based on a mutual risk appetite of the mutual fund investor 301 and fund manager of the fund management platform 115. In yet another embodiment, the determination of the split percentage of the financial investment by the fund management platform 115 may be opportunity driven, for example, investments, redemptions, and/or the like. In another embodiment, the fund management platform 115 may determine the split percentage of the financial investment based on parameters, such as, but not limited to market research analysis, the fund manager's experience, and/or the like.

Further, the fund management platform 115 may invest in the publicly traded securities 302 and private placements 306 based on the determined split percentage of the financial investment. In an exemplary scenario, the fund management platform 115 may determine that 80% of the financial investment may be invested in the publicly traded securities 302 and 20% of the financial investment may be invested in the private placements 306. While investing in the publicly traded securities 302, the fund management platform 115 may invest in securities that may manage or have exposure to, but not restricted to, illiquid assets 304. The illiquid asset may include, but not restricted to, a Private Equity (PE), a Business Development Company (BDC), a Real Estate (RE), infrastructure, and/or the like. These publicly traded securities 302 may trade with the Securities and Exchange Commission (SEC) under the Investment Company Act of 1940.

The fund management platform 115 may invest in the private placements 306 via the SPVs, in an embodiment. The private placements 306 may require money over multiple years then the SPVs may balance the cash flow needs of the private placements 306 with liquid options. The liquid options may include, but are not restricted to, bonds, cash, commodities, shares of stock, and/or the like. The fund management platform 115 may communicate with secondary funds 308 that may act as a liquidity mechanism. In an embodiment, more than one secondary fund may be available for trading purposes. The fund management platform 115 may have an agreement of intent from managers of the secondary funds 308. In one embodiment, the agreement may state that the managers of secondary funds 308 may at any time purchase funds 310 associated with the private placements 306 if the fund management platform 115 desires to sell the funds 310 associated with the private placements 306. In another embodiment, the agreement may state that the managers of secondary funds 308 may at any time sell the funds 310 associated with the private placements 306 if the fund management platform 115 desires to purchase the funds 310 associated with the private placements 306. In an embodiment, the funds 310 may also be associated with private equity of the mutual fund investor 301. In one embodiment, a manager of a fund may be a special purpose computing system capable of performing the process steps of the present invention.

In an embodiment, the need to purchase and/or sell the funds 310 associated with the private placements 306 which may arise in general to balance the cash flow stored in a treasury 312. In an exemplary scenario, the treasury 312 may be a private fund sponsor that manages mutual funds of the one or more users, provides its services to the SPVs, fund managers of the fund management platform 115, and/or the like. In another embodiment, the need to purchase and/or sell the funds 310 associated with the private placements may arise when the users and/or the manager of the fund management platform 115 may desire to liquidate the private placements 306 along with the publicly traded securities 302. In an embodiment, the funds 310 associated with the private placements 306 may be sold at a mutually agreeable price between the fund management platform 115 and the manager of the secondary funds 308. In another embodiment, the funds 310 associated with the private placements 306 may be sold at a pre-defined price that may be defined at the time of the agreement of intent. The cash received from the secondary funds may be stored in the treasury 312. Further, the fund management platform 115 desires to invest in any private placements 306, publicly traded securities 302, or a combination thereof, the manager of the fund management platform 115 may utilize the treasure stored in the treasury 312, in an embodiment. Therefore, the mutual fund investor 301 may at any time sell and/or purchase the funds 310 associated with the private placements 306 within the open-end mutual fund framework.

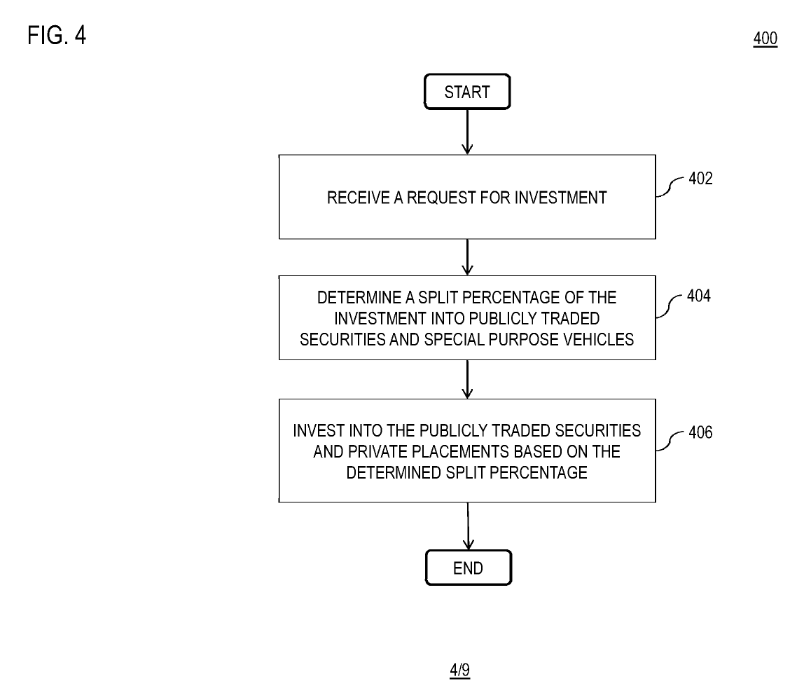

FIG. 4 is a flowchart of a process 400 for managing financial investments, according to one embodiment. At step 402, the fund management platform 115 receives a request from the mutual fund investor 301. The received request may be to manage financial investments within open-end mutual funds framework offered in private placements, according to an embodiment.

Next, at step 404, the fund management platform 115 determines a split percentage of the financial investment that is to be invested in publicly traded companies, according to an embodiment. The financial investment may be invested in private placements, according to another embodiment. The financial investment may be invested in both the publicly traded securities and the private placements, according to yet another embodiment.

Then, at step 406, the fund management platform 115 may determine the split percentage of the financial investment based on risk appetite of the mutual fund investor 301, in an embodiment. In another embodiment, the fund management platform 115 may determine the split percentage of the financial investment based on the risk appetite of the fund manager of the fund management platform 115. In yet another embodiment, the fund management platform 115 may determine the split percentage of the financial investment based on a mutual risk appetite of the mutual fund investor 301 and the fund management platform 115. In yet another embodiment, the determination of the split percentage of the financial investment by the fund management platform 115 may be opportunity driven, for example, investments, redemptions, and/or the like. In one embodiment, the fund management platform 115 may invest into the publicly traded securities, and private placements based on the determined split percentage of the financial investment. In another embodiment, the fund management platform 115 may invest into the publicly traded securities and private placements through SPVs.

While investing in the publicly traded securities, the fund management platform 115 may invest in securities that may manage or have exposure to, but not restricted to, illiquid assets. The illiquid asset may include, but not restricted to, a Private Equity (PE), a Business Development Company (BDC), a Real Estate (RE), infrastructure, and/or the like. The fund management platform 115 may invest in the private placements via the SPVs, in an embodiment. The private placements may require money over multiple years, then the SPVs may balance the cash flow needs of the private placements 306 with liquid options for example, bonds, cash, commodities, shares of stock, and/or the like. In one embodiment, the fund management platform 115 may transact the proceeds or gains from the investments into a bank or investment accounts of an investor.

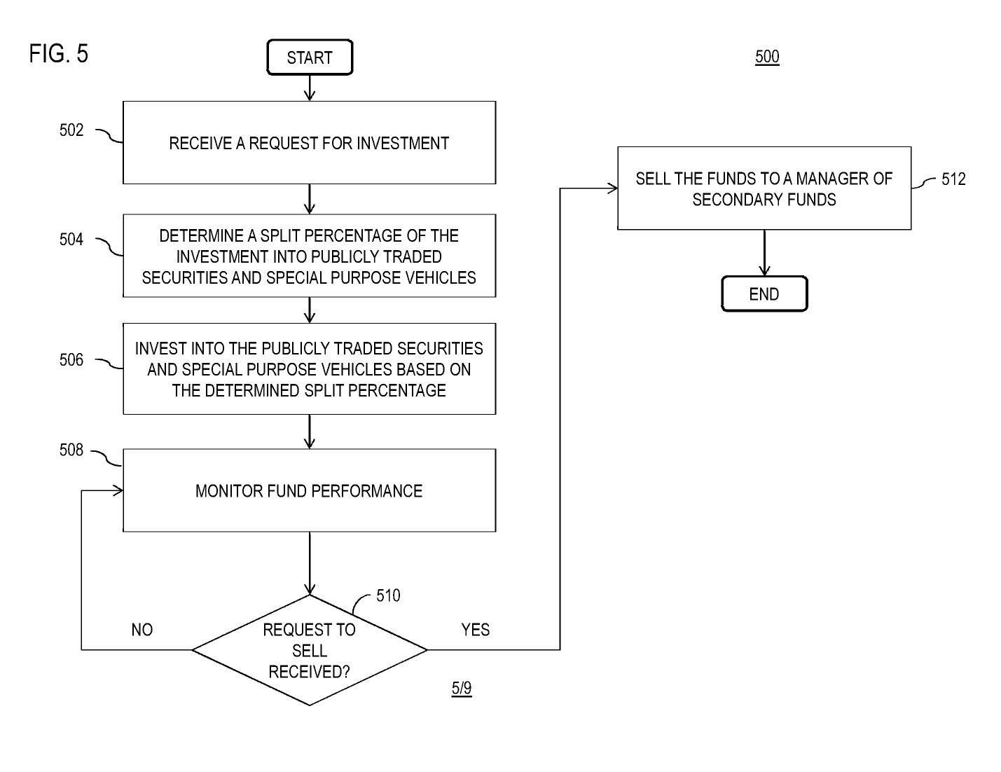

FIG. 5 is a flowchart of a process 500 for managing financial investments, according to another embodiment. At step 502, the fund management platform 115 receives a request from the mutual fund investor 301. The received request may be to manage financial investments within open-end mutual funds framework offered in private placements, according to an embodiment.

Next, at step 504, the fund management platform 115 determines a split percentage of the financial investment that is to be invested in publicly traded companies, according to an embodiment. The financial investment may be invested in private placements, according to another embodiment. The financial investment may be invested in both the publicly traded securities and the private placements, according to yet another embodiment. The fund management platform 115 may determine the split percentage of the financial investment based on risk appetite of the mutual fund investor 301, in an embodiment. In another embodiment, the fund management platform 115 may determine the split percentage of the financial investment based on the risk appetite of the fund manager of the fund management platform 115. In a further embodiment, the fund management platform 115 may determine the split percentage of the financial investment based on a mutual risk appetite of the mutual fund investor 301 and fund manager of the fund management platform 115. In yet another embodiment, the determination of the split percentage of the financial investment by the fund management platform 115 may be opportunity driven, for example, investments, redemptions, and/or the like.

Then, at step 506, the fund management platform 115 may invest into the publicly traded securities, and private placements through SPVs. In an embodiment of the private invention, the fund management platform 115 may invest into the publicly traded securities, and private placements based on the determined split percentage of the financial investment. While investing in the publicly traded securities, the fund management platform 115 may invest in securities that may manage or have exposure to, but not restricted to, illiquid assets. The illiquid assets may include, but not restricted to, a Private Equity (PE), a Business Development Company (BDC), a Real Estate (RE), infrastructure, and/or the like. The fund management platform 115 may invest in the private placements via the SPVs, in an embodiment. The private placements may require money over multiple years, then the SPVs may balance the cash flow needs of the private placements 306 with liquid options for example, bonds, cash, commodities, shares of stock, and/or the like.

Thereafter, at step 508, the fund management platform 115 may monitor performance of funds associated with the private placements. The return on an investment may be measured over a given time period by summing its capital appreciation and income generated and dividing the summation by the original amount of the investment. This may be expressed as a percentage value. In an exemplary scenario, if the return is a higher value then the fund's performance may be measured as profitable. The return may be calculated in two ways. First, an absolute return that may be defined as an increase or a decrease in the financial investment in terms of percentage value. Next, annualized return may be defined as rate of return over a given period of investment, such as annually.

Further, at step 510, the fund management platform 115 determines whether a request to sell funds is received. If the funds do not provide satisfactory returns then a request to sell the funds may be received from the mutual fund investor 301 or the fund manager of the fund management platform 115. If the request to sell the funds is received, the process 500 proceeds towards step 512. Otherwise, the process 500 returns to the step 508 and continues monitoring of the fund performance.

At step 512, the fund management platform 115 may sell the funds to a manager of the secondary funds 308, according to an embodiment. In an embodiment, the funds may be sold at a mutually agreeable price between the fund manager of the fund management platform 115 and the manager of the secondary funds 308. In another embodiment, the funds may be sold at a pre-defined price that may be defined at the time of the agreement of intent with the secondary funds 308. In one embodiment, the fund management platform 115 may transact the proceeds or gains from the investments into a bank or investment accounts of an investor. In another embodiment, the investor may be paid in cash.

In one embodiment the fund management platform 115 may display the performance of the funds on a Graphical User Interface (GUI). Further, the investors may interact with the GUI of the fund management platform 115 to invest, sell, and/or purchase the financial instruments.

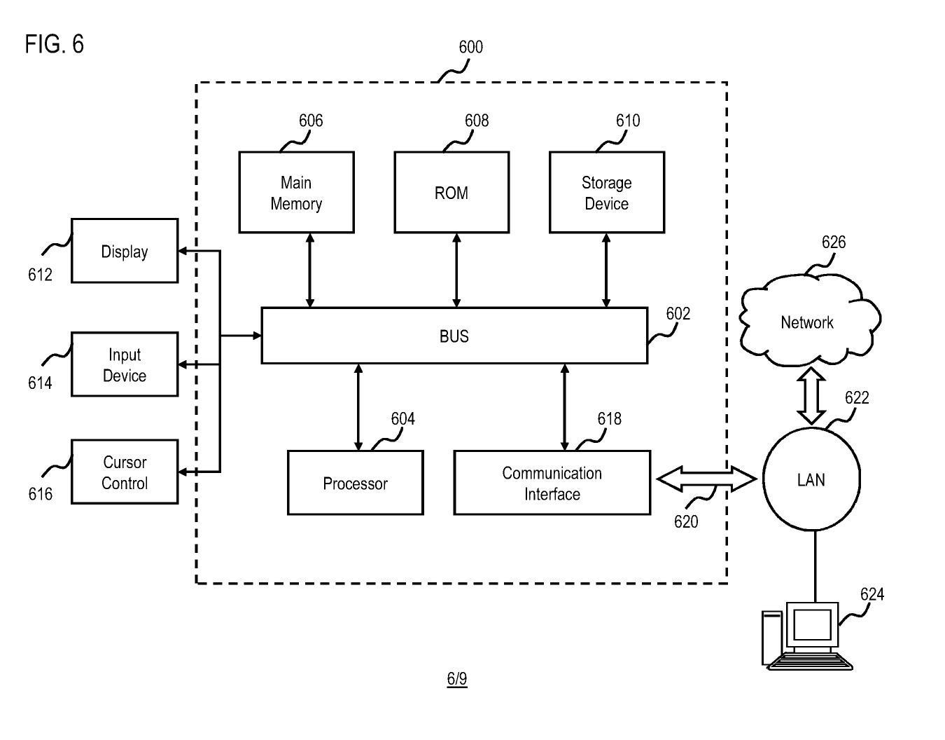

FIG. 6 is a diagram of a computer system that can be used to implement various exemplary embodiments. The computer system 600 includes a bus 602 or other communication mechanism for communicating information and one or more processors (of which one is shown) 604 coupled to the bus 602 for processing information. The computer system 600 also includes main memory 606, such as a Random Access Memory (RAM) or other dynamic storage device, coupled to the bus 602 for storing information and instructions to be executed by the processor 604. Main memory 606 can also be used for storing temporary variables or other intermediate information during execution of instructions by the processor 604. The computer system 600 may further include a Read Only Memory (ROM) 608 or other static storage device coupled to the bus 602 for storing static information and instructions for the processor 604. A storage device 610, such as a magnetic disk, a solid state disk, or optical disk, is coupled to the bus 602 for persistently storing information and instructions.

The computer system 600 may be coupled via the bus 602 to a display 612, such as a Cathode Ray Tube (CRT), liquid crystal display, Light Emitting Diode (LED) display, organic LED display, active matrix display, Electrophoretic Display (EPD), or plasma display, for displaying information to a computer user. Further, the display 612 may be a touch-enabled display such as capacitive or resistive screen. An input device 614, such as a keyboard including alphanumeric and other keys, is coupled to the bus 602 for communicating information and command selections to the processor 604. Another type of user input device is a cursor control 616, such as a mouse, a trackball, or cursor direction keys, for communicating direction information and command selections to the processor 604 and for adjusting cursor movement on the display 612.

According to an embodiment of the invention, the processes described herein are performed by the computer system 600, in response to the processor 604 executing an arrangement of instructions contained in main memory 606. Such instructions can be read into main memory 606 from another computer-readable medium, such as the storage device 610. Execution of the arrangement of instructions contained in the main memory 606 causes the processor 604 to perform the process steps described herein. One or more processors in a multiprocessing arrangement may also be employed to execute the instructions contained in main memory 606. In alternative embodiments, hard-wired circuitry may be used in place of or in combination with software instructions to implement the embodiment of the invention. Thus, embodiments of the invention are not limited to any specific combination of hardware circuitry and software.

The computer system 600 also includes a communication interface 618 coupled to bus 602. The communication interface 618 provides a two-way data communication coupling to a network link 620 connected to a local network 622. For example, the communication interface 618 may be a Digital Subscriber Line (DSL) card or modem, an Integrated Services Digital Network (ISDN) card, a cable modem, a telephone modem, or any other communication interface to provide a data communication connection to a corresponding type of communication line. As another example, the communication interface 618 may be a Local Area Network (LAN) card (e.g., for Ethernet™ or an Asynchronous Transfer Model (ATM) network) to provide a data communication connection to a compatible LAN. Wireless links can also be implemented. In any such implementation, the communication interface 618 sends and receives electrical, electromagnetic, or optical signals that carry digital data streams representing various types of information. Further, the communication interface 618 can include peripheral interface devices, such as a Universal Serial Bus (USB) interface, thunderbolt interface, a Personal Computer Memory Card International Association (PCMCIA) interface, etc. Although a single communication interface 618 is depicted, multiple communication interfaces can also be employed.

The network link 620 typically provides data communication through one or more networks to other data devices. For example, the network link 620 may provide a connection through local network 622 to a host computer 624, which has connectivity to a network 626 (e.g., a Wide Area Network (WAN) or the global packet data communication network now commonly referred to as the “Internet”) or to data equipment operated by a service provider. The local network 622 and the network 626 both use electrical, electromagnetic, or optical signals to convey information and instructions. The signals through the various networks and the signals on the network link 620 and through the communication interface 618, which communicate digital data with the computer system 600, are exemplary forms of carrier waves bearing the information and instructions.

The computer system 600 can send messages and receive data, including program code, through the network(s), the network link 620, and the communication interface 618. In the Internet example, a server (not shown) might transmit requested code belonging to an application program for implementing an embodiment of the invention through the network 626, the local network 622 and the communication interface 618. The processor 604 may execute the transmitted code while being received and/or store the code in the storage device 610, or other non-volatile storage for later execution. In this manner, the computer system 600 may obtain application code in the form of a carrier wave.

The term “computer-readable medium” as used herein refers to any medium that participates in providing instructions to the processor 604 for execution. Such a medium may take many forms, including but not limited to computer-readable storage medium ((or non-transitory)—i.e., non-volatile media and volatile media), and transmission media. Non-volatile media include, for example, optical or magnetic disks, such as the storage device 610. Volatile media include dynamic memory, such as the main memory 606. Transmission media include coaxial cables, copper wire and fiber optics, including the wires that comprise the bus 602. Transmission media can also take the form of acoustic, optical, or electromagnetic waves, such as those generated during Radio Frequency (RF) and infrared (IR) data communications. Common forms of computer-readable media include, for example, a floppy disk, a flexible disk, hard disk, magnetic tape, any other magnetic medium, a USB flash drive, a CD-ROM, CD-RW, DVD, a Blu-ray disk, any other optical medium, punch cards, paper tape, optical mark sheets, any other physical medium with patterns of holes or other optically recognizable indicia, a RAM, a PROM, and EPROM, a FLASH-EPROM, any other memory chip or cartridge, a carrier wave, or any other medium from which a computer can read.

Various forms of computer-readable media may be involved in providing instructions to a processor for execution. For example, the instructions for carrying out at least part of the embodiments of the invention may initially be borne on a magnetic disk of a remote computer. In such a scenario, the remote computer loads the instructions into main memory and sends the instructions over a telephone line using a modem. A modem of a local computer system receives the data on the telephone line and uses an infrared transmitter to convert the data to an infrared signal and transmit the infrared signal to a portable computing device, such as a Personal Digital Assistant (PDA) or a laptop. An infrared detector on the portable computing device receives the information and instructions borne by the infrared signal and places the data on a bus. The bus conveys the data to main memory, from which a processor retrieves and executes the instructions. The instructions received by main memory can optionally be stored on storage device either before or after execution by processor.

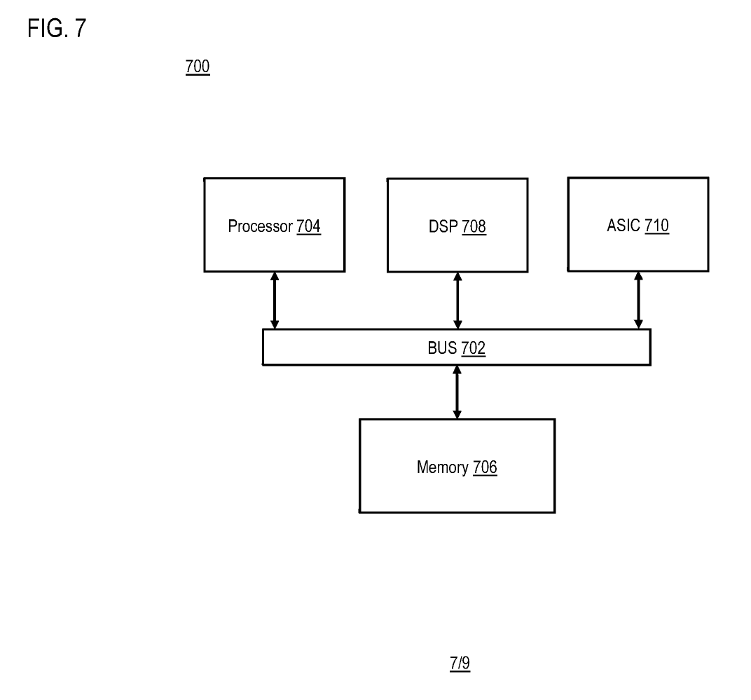

FIG. 7 illustrates a chip set or chip 700 upon which an embodiment of the invention may be implemented. Chip set 700 is programmed to deliver messages to a user based on their activity status as described herein and includes, for instance, the processor and memory components described with respect to FIG. 7 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 700 can be implemented in a single chip. It is further contemplated that in certain embodiments the chip set or chip 700 can be implemented as a single ‘system on a chip’. It is further contemplated that in certain embodiments a separate ASIC would not be used, for example, and that all relevant functions as disclosed herein would be performed by a processor or processors. Chip set or chip 700, or a portion thereof, constitutes a means for performing one or more steps of enabling the transmission of files independent of a file transfer application or the throughput capabilities of the sending or receiving devices.

In one embodiment, the chip set or chip 700 includes a communication mechanism such as a bus 702 for passing information among the components of the chip set 700. A processor 704 has connectivity to the bus 702 to execute instructions and process information stored in, for example, a memory 706. The processor 704 may include one or more processing cores with each core configured to perform independently. A multi-core processor enables multiprocessing within a single physical package. Examples of a multi-core processor include two, four, eight, or greater numbers of processing cores. Alternatively or in addition, the processor 704 may include one or more microprocessors configured in tandem via the bus 702 to enable independent execution of instructions, pipelining, and multithreading. The processor 704 may also be accompanied with one or more specialized components to perform certain processing functions and tasks such as one or more Digital Signal Processors (DSP) 708, or one or more Application-Specific Integrated Circuits (ASIC) 710. The DSP 708 typically is configured to process real-world signals (e.g., sound) in real time independently of the processor 704. Similarly, the ASIC 710 can be configured to performed specialized functions not easily performed by a more general purpose processor. Other specialized components to aid in performing the inventive functions described herein may include one or more Field Programmable Gate Arrays (FPGA) (not shown), one or more controllers (not shown), or one or more other special-purpose computer chips.

In one embodiment, the chip set or chip 700 includes merely one or more processors and some software and/or firmware supporting and/or relating to and/or for the one or more processors.

The processor 704 and accompanying components have connectivity to the memory 706 via the bus 702. The memory 706 includes both dynamic memory (e.g., RAM, magnetic disk, writable optical disk, etc.) and static memory (e.g., ROM, CD-ROM, etc.) for storing executable instructions that when executed perform the inventive steps described herein to manage the investments. The memory 706 also stores the data associated with or generated by the execution of the inventive steps.

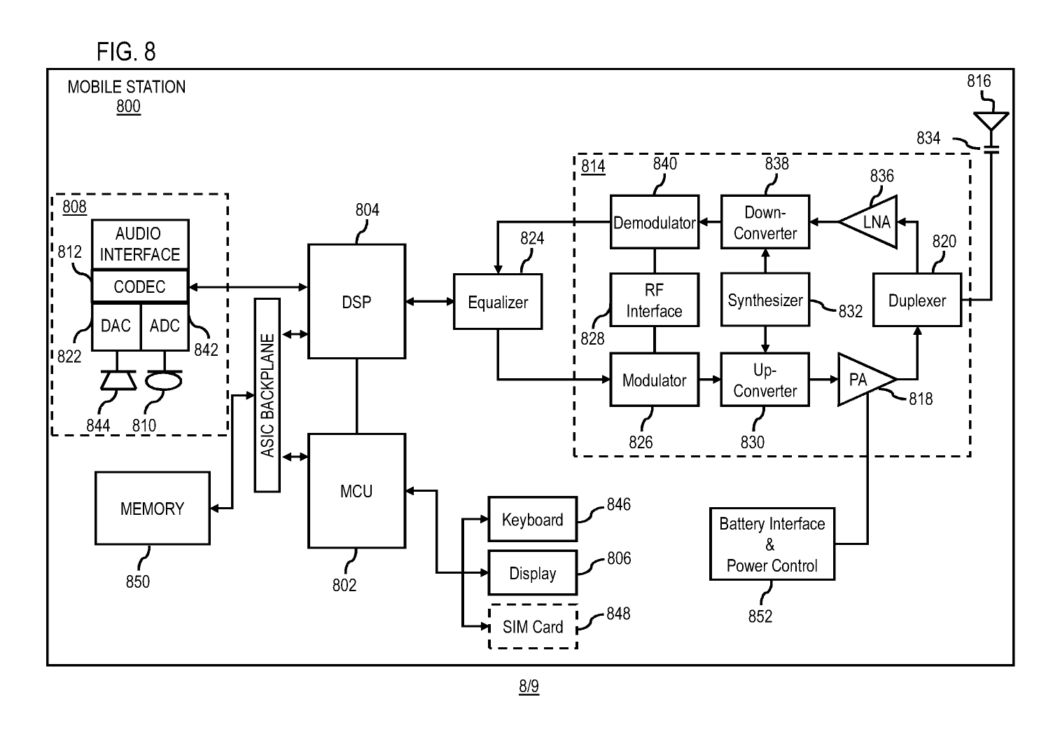

FIG. 8 is a diagram of exemplary components of a mobile terminal (e.g., handset) 800 for communications, which is capable of operating in the system of FIG. 1, according to one embodiment. In some embodiments, mobile terminal 800, or a portion thereof, constitutes a means for performing investment management. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including Digital Signal Processor(s), software, and memory that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 802, a Digital Signal Processor (DSP) 804, and a receiver/transmitter unit including a microphone gain control unit and a speaker gain control unit. A main display unit 806 provides a display to the user in support of various applications and mobile terminal functions that perform or support the steps of managing investments. The display 806 includes display circuitry configured to display at least a portion of a user interface of the mobile terminal 800 (e.g., mobile telephone). Additionally, the display 806 and display circuitry are configured to facilitate user control of at least some functions of the mobile terminal 800. An audio function circuitry 808 includes a microphone 810 and microphone amplifier that amplifies the speech signal output from the microphone 810. The amplified speech signal output from the microphone 810 is fed to a coder/decoder (CODEC) 812.

A radio section 814 amplifies power and converts frequency in order to communicate with a base station, which is included in a mobile communication system, via antenna 816. The antenna 816 may work on Multiple Input Multiple Output (MIMO). MIMO is generally a part of wireless communication standards, such as IEEE 802.11 (WiFi), 3G, WiMAX (4G), Long Term Evolution (LTE), and/or the like. The Power Amplifier (PA) 818 and the transmitter/modulation circuitry are operationally responsive to the MCU 802, with an output from the PA 818 coupled to the duplexer 820 or circulator or antenna switch, as known in the art. The PA 818 also couples to a battery interface and power control unit 852.

In use, a user of mobile terminal 800 speaks into the microphone 810 and his or her voice along with any detected background noise is converted into an analog voltage. The analog voltage is then converted into a digital signal through the Analog to Digital Converter (ADC) 822. The control unit 802 routes the digital signal into the DSP 804 for processing therein, such as speech encoding, channel encoding, encrypting, and interleaving. In one embodiment, the processed voice signals are encoded, by units not separately shown, using a cellular transmission protocol such as Enhanced Data Rates For Global Evolution (EDGE), General Packet Radio Service (GPRS), Global System For Mobile Communications (GSM), Internet Protocol Multimedia Subsystem (IMS), Universal Mobile Telecommunications System (UMTS), etc., as well as any other suitable wireless medium, e.g., microwave access (WiMAX), Long Term Evolution (LTE) networks, Code Division Multiple Access (CDMA), Wideband Code Division Multiple Access (WCDMA), Wireless Fidelity (WiFi), satellite, and/or the like, or any combination thereof.

The encoded signals are then routed to an equalizer 824 for compensation of any frequency-dependent impairments that occur during transmission though the air such as phase and amplitude distortion. After equalizing the bit stream, the modulator 826 combines the signal with a RF signal generated in the RF interface 828. The modulator 826 generates a sine wave by way of frequency or phase modulation. In order to prepare the signal for transmission, an up-converter 830 combines the sine wave output from the modulator 826 with another sine wave generated by a synthesizer 832 to achieve the desired frequency of transmission. The signal is then sent through the PA 818 to increase the signal to an appropriate power level. In practical systems, the PA 818 acts as a variable gain amplifier whose gain is controlled by the DSP 804 from information received from a network base station. The signal is then filtered within the duplexer 820 and optionally sent to an antenna coupler 834 to match impedances to provide maximum power transfer. Finally, the signal is transmitted via antenna 816 to a local base station. An Automatic Gain Control (AGC) can be supplied to control the gain of the final stages of the receiver. The signals may be forwarded from there to a remote telephone which may be another cellular telephone, any other mobile phone or a land-line connected to a Public Switched Telephone Network (PSTN), or other telephony networks.

Voice signals transmitted to the mobile terminal 800 are received via the antenna 816 and immediately amplified by a Low Noise Amplifier (LNA) 836. A down-converter 838 lowers the carrier frequency while the demodulator 840 strips away the RF leaving only a digital bit stream. The signal then goes through the equalizer 824 and is processed by the DSP 804. A Digital to Analog Converter (DAC) 822 converts the signal and the resulting output is transmitted to the user through a speaker 844, all under control of a Main Control Unit (MCU) 802 which can be implemented as a Central Processing Unit (CPU).

The MCU 802 receives various signals including input signals from the keyboard 846. The keyboard 846 and/or the MCU 802 in combination with other user input components (e.g., the microphone 810) comprise a user interface circuitry for managing user input. The MCU 802 runs user interface software to facilitate user control of at least some functions of the mobile terminal 800 to adjust one or more device functionalities based on location, movement, noise, or a combination thereof. The MCU 802 also delivers a display command and a switch command to the display 806 and to the speech output switching controller, respectively. Further, the MCU 802 exchanges information with the DSP 804 and can access an optionally incorporated SIM card 848 and a memory 850. In addition, the MCU 802 executes various control functions required of the terminal. The DSP 804 may, depending upon the implementation, perform any of a variety of conventional digital processing functions on the voice signals. Additionally, the DSP 804 determines the background noise level of the local environment from the signals detected by the microphone 810 and sets the gain of microphone 810 to a level selected to compensate for the natural tendency of the user of the mobile terminal 800.

The CODEC 812 includes the ADC 842 and DAC 822. The memory 850 stores various data including call incoming tone data and is capable of storing other data including music data received via, e.g., the global Internet. The software module could reside in RAM memory, flash memory, registers, or any other form of writable storage medium known in the art. The memory device 850 may be, but not limited to, a single memory, CD, DVD, ROM, RAM, EEPROM, optical storage, magnetic disk storage, flash memory storage, or any other non-volatile storage medium capable of storing digital data.

An optionally incorporated SIM card 848 carries, for instance, important information, such as the cellular phone number, the carrier supplying service, subscription details, and security information. The SIM card 848 serves primarily to identify the mobile terminal 800 on a radio network. The SIM card 848 also contains a memory for storing a personal telephone number registry, text messages, and user specific mobile terminal settings.

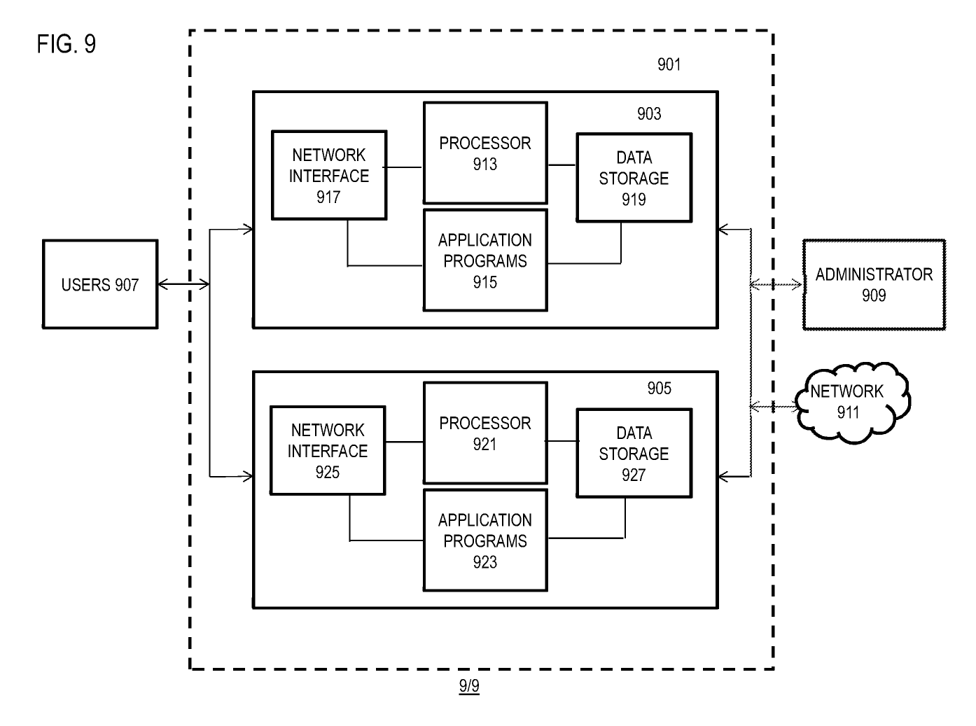

FIG. 9 is a diagram illustrating a back end server, back end, cloud computing architecture, or server farm 901 upon which an embodiment of the invention may be implemented. A server or server farm 901 is programmed to manage private placement investments as described herein and each server 903 may include, for instance, a processor (913, 921), an application (915, 923), and a network interface 911 incorporated in one or more physical packages. By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the server farm can be implemented through a single server. Server farm 901 can comprise a plurality of servers (903, 905), such as special purpose server computers that are designed to manage and store data (e.g., store custom applications used to serve user requests such as user login authentication, store user data for custom application needs, and/or perform customized processing, not directly taking traffic from end users, but performing (constant) offline processing). It is further contemplated that a server in a data storage and management network, such as a server farm, can be a device attached to the network as a connection point, redistribution point or communication endpoint. A server may be capable of storing, sending, receiving, and/or forwarding information for a network, and could comprise any device that meets any or all of these criteria. Server farm 901 or server 903, or a portion thereof, constitutes a means for performing one or more steps of managing private placement investments. Server farm 901 or server 903, or a portion thereof, constitutes a means for performing one or more steps of managing private placement investments.

In one embodiment, a plurality of users 907 may be connected to the server farm 901 over a connection network, such as the Internet. As an example, a server farm may be part of an Internet-based services network (e.g., search engine, map service, virtual storage) that allows users 907 to retrieve information that may be stored on or accessed by the server farm 901. The server farms can be further connected to other networks 911, such as the Internet, for updating and retrieving information stored on the servers (903, 905) in the server farm 901.

In one embodiment, the server farm 901 or servers (903, 905) include a communication mechanism such as a network interface or router (917, 925) for passing information among the servers of the server farm 901. A processor (913, 921) has connectivity to the network interface (917, 925) to execute instructions and process information stored in, for example, a data storage unit (919, 927). The processor (913, 921) may include one or more processing cores with each core configured to perform independently. A multi-core processor enables multiprocessing within a single physical package. Examples of a multi-core processor include two, four, eight, or greater numbers of processing cores. Alternatively or in addition, the processor (913, 921) may include one or more microprocessors configured in tandem via a bus to enable independent execution of instructions, pipelining, and multithreading. The processor (913, 921) may also be accompanied with one or more specialized components to perform certain processing functions and tasks such as one or more digital signal processors (DSP) (not shown), or one or more application-specific integrated circuits (ASIC) (not shown). A DSP typically is configured to process real-world signals (e.g., sound) in real time independently of the processor (913, 921). Similarly, an ASIC can be configured to perform specialized functions not easily performed by a more general purpose processor. Other specialized components to aid in performing the inventive functions described herein may include one or more field programmable gate arrays (FPGA) (not shown), one or more controllers (not shown), or one or more other special-purpose computer chips.

Servers (903, 905) respectively correspond to the application programs (915, 923). After the back-end servers (903, 905) receive the user command from the high-speed network 911, the network interfaces (917, 925) send the user command to the processors (913, 921). The processors (913, 921) may then send the user command to the application programs (915, 923). The application programs (915, 923) then execute an execution code according to the user command to generate an execution result. A processing then generates processed outputs corresponding to the application programs (915, 923) according to the execution result. In one embodiment, the processors comprise an engine, a decoder/encoder, and a stream process unit. In addition, the application programs (915, 923) may execute the execution code to generate a data stream. The network interfaces (917, 925) may then send the code corresponding to the application programs (915, 923) data stream to a front-end server via the network 911.

Data flow in a typical user environment involves creation of digital data as well as uploading the data to a device, backing up data, encrypting data, and compressing data before transfer. Each of the servers typically has a local data store containing various usable data types for these purposes. A user may back data up from each of local data stores (the computer, cell phone, PDA, etc.) to the servers (903, 905) as a centralized back-end data store, incorporated into a server farm 901. These back end server farms include servers (903, 905) that are typically fault tolerant, and may include multiple redundant data stores such as hard disc “farms” connected to the Internet. Various architectures may be used, as is known in the art. The server farm may incorporate with an authenticating and load balancing on the front end as well as a SMS/MMS gateway. Thus, the user communicates with the server farm through the front end and the gateway, and thereby obtains access to the servers (903, 905).

Further, in one embodiment, the hardware configurations for servers in the server farm may be heterogeneous. For example, when a new server is added to the server farm, or a hardware upgrade is undertaken, the newly installed hardware may be different than the existing servers or hardware. Therefore, in this embodiment, when identifying the servers in the server farm, two or more servers may be heterogeneous, comprising different hardware configurations.

Typically, one or more administrators 909 are tasked with managing the server farm's operations, which can include ongoing software and hardware maintenance, as well as planning for capacity increases based on user traffic. For example, as more users 907 access the server farm, and/or more services are added to the server farm, a corresponding increase in user traffic is likely. Therefore, in this example, an administrator 909 may wish to plan for adding hardware and/or software resources to the server farm based on the increase in traffic.

In one embodiment, a method comprises determining an investment allocation among one or more publicly traded investments and one or more private placement investments. The method also comprises initiating the one or more private placement investments via a SPV based on the investment allocation. In one embodiment, the SPV for the one or more private placement investments includes a letter of intent from a first investor to purchase one or more shares of the one or more private placement investments from the a second investor.

In one embodiment, the method further comprises receiving a request to sell the one or more private placement investments via the SPV by the second investor. The method further comprises initiating a sale of the one or more private placement investments from the second investor to the first investor based on the letter of intent.

In one embodiment, the method comprises initiating the request to sell based on a rebalancing request, a request from an underlying fund investor, or a combination thereof.

In one embodiment, the method comprises determining one or more terms of the sale based on the letter of intent.

In one embodiment, the one or more terms are specified at a time of the letter of intent, the sale, or a combination thereof.

In one embodiment, the one or more terms include a price of the one or more shares.

In one embodiment, the first investor, the second investor, or combination thereof includes a manager of a secondary fund.

In one embodiment, the one or more publicly traded investments are based on illiquid assets.

In one embodiment, the method comprises querying for the letter of intent from at least one data source. The method also comprises initiating of the one or more private placement investments are based on the querying.

In one embodiment, the method comprises determining the investment allocation based on one or more risk criteria.

In one embodiment, the method comprises determining the investment allocation based on identified market opportunities.

In one embodiment, the publicly traded investments are offered by entities that manage, or have exposure to, illiquid assets.

According to another embodiment, an apparatus comprises at least one processor, and at least one memory including computer program code for one or more computer programs, the at least one memory and the computer program code configured to, with the at least one processor, cause, at least in part, the apparatus to determine an investment allocation among one or more publicly traded investments and one or more private placement investments. The apparatus is also caused to initiate the one or more private placement investments via a SPV based on the investment allocation. In one embodiment, the SPV for the one or more private placement investments includes a letter of intent from a first investor to purchase one or more shares of the one or more private placement investments from the a second investor.

In one embodiment, the apparatus is further caused to initiate the request to sell based on a rebalancing request, a request from an underlying fund investor, or a combination thereof.

In one embodiment, the apparatus is further caused to determine one or more terms of the sale based on the letter of intent.

In one embodiment, the apparatus is further caused to query for the letter of intent from at least one data source. The apparatus is also caused to initiate the one or more private placement investments are based on the querying.

In one embodiment, the apparatus is also caused to determine the investment allocation based on one or more risk criteria.

In one embodiment, the apparatus is also caused to determine the investment allocation based on identified market opportunities.

In one embodiment, the method comprises publicly traded investments are offered by entities that manage, or have exposure to, illiquid assets.

According to another embodiment, a computer-readable storage medium carrying one or more sequences of one or more instructions which, when executed by one or more processors, cause, at least in part, an apparatus to determine an investment allocation among one or more publicly traded investments and one or more private placement investments. The apparatus is also caused to initiate the one or more private placement investments via a SPV based on the investment allocation. In one embodiment, the SPV for the one or more private placement investments includes a letter of intent from a first investor to purchase one or more shares of the one or more private placement investments from the a second investor.

While certain exemplary embodiments and implementations have been described herein, other embodiments and modifications will be apparent from this description. Accordingly, the invention is not limited to such embodiments, but rather to the broader scope of the presented claims and various obvious modifications and equivalent arrangements.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

1. A computer implemented method for administering financial portfolio of a user, the method comprising:
receiving by a fund managing entity associated with a computer over a network a request from a device associated with the user for managing financial resources;
determining by the fund managing entity a split percentage for the financial resources based, at least in part, on a risk level;
investing by the fund managing entity the financial resources in a publicly traded security, a private placement, or a combination thereof based, at least in part, on the split percentage; and
monitoring by the fund managing entity performances of the financial resources invested in the publicly traded security, the private placement, or a combination thereof.

2. A method of claim 1, wherein the risk levels includes user defined risk criteria, manager defined risk criteria, opportunity driven risk criteria, or a combination thereof.

3. A method of claim 1, wherein the monitoring by the fund managing entity the performances of the financial resources further includes:
calculating a return on the financial resources invested in the publicly traded security, the private placement, or a combination thereof,
wherein the return on the financial resources is calculated by summing capital appreciation and income generation for the financial resources and dividing by the original amount of the financial resources.

4. A method of claim 3, further comprising:
selling the financial resources invested in the publicly traded security, the private placement, or a combination thereof to a manager of a secondary fund based, at least in part, on a determination that the return on the financial resources is decreasing,
wherein the invested financial resources is sold at a pre-defined price, a mutually agreeable price, or a combination thereof.

5. A method of claim 4, further comprising:
querying one or more databases for one or more transaction terms in one or more agreements,
wherein the one or more agreements include a letter of intent, a firm purchase agreement, a sales agreement, or a combination thereof; and
determining the one or more transaction terms based on the querying, a default rule, or a combination thereof.

6. A method of claim 3, further comprising:
purchasing the financial resources invested in the publicly traded security, the private placement, or a combination thereof from the manager of the secondary fund based, at least in part, on a determination that return on the financial resources is increasing,
wherein the invested financial resources is purchased at a pre-defined price, a mutually agreeable price, or a combination thereof.

7. A method of claim 3, wherein the return on the financial resources invested in the publicly traded security, the private placement, or a combination thereof is calculated in terms of an absolute return, an annualized return, or a combination thereof, and expressed as a percentage value.

8. A method of claim 1, further comprising:
presenting the performance of the invested financial resources in at least one graphical user interface (GUI) of at least one device,
wherein the user may interact with the GUI to invest, sell or purchase the financial resources.

9. A method of claim 1, further comprising:
designating a higher risk level for the financial resources invested in the private placement.

10. A method of claim 9, further comprising:
specifying a higher percentage split in the private placement for the user with higher risk defined criteria and a lower percentage split in the private placement for the user with a lower risk defined criteria.

11. An apparatus comprising:
at least one processor; and
at least one memory including computer program code for one or more programs,
the at least one memory and the computer program code configured to, with the at least one processor, cause the apparatus to perform at least the following,
receive a request from a device associated with the user for managing financial resources;
determine a split percentage for the financial resources based, at least in part, on a risk level;
invest the financial resources in a publicly traded security, a private placement, or a combination thereof based, at least in part, on the split percentage; and
monitor performances of the financial resources invested in the publicly traded security, the private placement, or a combination thereof.

12. An apparatus of claim 11, wherein the risk levels includes user defined risk criteria, manager defined risk criteria, opportunity driven risk criteria, or a combination thereof.

13. An apparatus of claim 11, wherein monitoring the performances of the financial resources include the apparatus is further caused to:
calculate a return on the financial resources invested in the publicly traded security, the private placement, or a combination thereof,
wherein the return on the financial resources is calculated by summing capital appreciation and income generation for the financial resources and dividing by the original amount of the financial resources.

14. An apparatus of claim 13, wherein the apparatus is further caused to:
selling the financial resources invested in the publicly traded security, the private placement, or a combination thereof to a manager of a secondary fund based, at least in part, on a determination that the return on the financial resources is decreasing,
wherein the invested financial resources is sold at a pre-defined price, a mutually agreeable price, or a combination thereof.

15. An apparatus of claim 14, wherein the apparatus is further caused to:
query one or more databases for one or more transaction terms in one or more agreements,
wherein the one or more agreements include a letter of intent, a firm purchase agreement, a sales agreement, or a combination thereof; and
determine the one or more transaction terms based on the querying, a default rule, or a combination thereof.

16. An apparatus of claim 13, wherein the apparatus is further caused to:
purchase the financial resources invested in the publicly traded security, the private placement, or a combination thereof from the manager of the secondary fund based, at least in part, on a determination that return on the financial resources is increasing,
wherein the invested financial resources is purchased at a pre-defined price, a mutually agreeable price, or a combination thereof.

17. An apparatus of claim 13, wherein the return on the financial resources invested in the publicly traded security, the private placement, or a combination thereof is calculated in terms of an absolute return, an annualized return, or a combination thereof, and expressed as a percentage value.

18. An apparatus of claim 11, wherein the apparatus is further caused to:
present the performance of the invested financial resources in at least one graphical user interface (GUI) of at least one device,
wherein the user may interact with the GUI to invest, sell or purchase the financial resources.

19. An apparatus of claim 11, wherein the apparatus is further caused to:
designate a higher risk level for the financial resources invested in the private placement.

20. An apparatus of claim 19, wherein the apparatus is further caused to:
specify a higher percentage split in the private placement for the user with higher risk defined criteria and a lower percentage split in the private placement for the user with a lower risk defined criteria.

21.-30. (canceled)
